(19) United States
(12) Patent Application Publication
(10) Pub. No.: US 2019/0041063 A1
(43) Pub. Date: Feb. 7, 2019

(54) PORTABLE GRILLING DEVICE WITH INTERLOCKING ARRANGEMENT AND RELATED METHODS

(71) Applicant: Rick Rauschart, Osteen, FL (US)

(72) Inventor: Rick Rauschart, Osteen, FL (US)

(21) Appl. No.: 15/670,633

(22) Filed: Aug. 7, 2017

(51) Int. Cl. F24C 1/16; F24C 15/10; A47J 37/07

(52) U.S. Cl. CPC F24C 1/16; F24C 15/107; A47J 37/0786; A47J 37/0704; A47J 37/0763

(57) ABSTRACT

A portable grilling device may include grill grate pieces being in an interlocking arrangement to define a grilling surface. Each grill grate piece may have first and second opposing arms, and a medial portion between the first and second opposing arms. A distal portion of the first opposing arm defines a recess, and a distal portion of the second opposing arm includes a tab portion extending outward therefrom. Respective recesses are configured to receive respective tab portions from adjacent grill grate pieces to define the interlocking arrangement.

### TECHNICAL FIELD

The present disclosure relates to the field of grilling devices, and, more particularly, to a portable grill device and related methods.

### BACKGROUND

The grilling industry is a robust and popular industry. Indeed, in the United States, the annual sales of grilling devices eclipse more than $1.5 billion in revenue. The activity of “grilling out” has become ubiquitous in American culture, being synonymous with Independence Day and summer holidays.

Because of the popularity of grilling activities, it is not uncommon for grill grates in grilling devices to become corroded and covered in charred remains. In fact, most grilling devices require routine maintenance to keep the grill grates clean and free of charred remains. This problem can be magnified in public grilling devices located at public parks. Since these grilling devices receive little regular maintenance, the grilling grates are typically in poor condition.

Also, due to the popularity of grilling activities, there is a desire to provide indoor grilling devices, which are typically electric resistive in design. These electric resistive approaches have at least a couple of potential drawbacks. First, their durability is poor, and with high use, they have a high failure rate. Secondly, they may not provide a well-drained grilling surface nor provide authentic flavoring.

### SUMMARY

Generally, a portable grilling device may include a plurality of grill grate pieces being in an interlocking arrangement to define a grilling surface. Each grill grate piece may comprise first and second opposing arms, and a medial portion between the first and second opposing arms. A distal portion of the first opposing arm may define a recess, and a distal portion of the second opposing arm may comprise a tab portion extending outward therefrom. Respective recesses may be configured to receive respective tab portions from adjacent grill grate pieces to define the interlocking arrangement.

In one embodiment, the distal portion of the first opposing arm may be C-shaped and defines the recess therein. The distal portion of the second opposing arm may define the tab portion comprising an L-shaped tab portion configured to be received by the C-shaped distal portion of the first opposing arm of the adjacent grill grate pieces.

In another embodiment, the distal portion of the first opposing arm may define the recess as a rectangle-shaped recess. The distal portion of the second opposing arm may define the tab portion comprising a trapezoid-shaped tab portion configured to be received by the rectangle-shaped recess of the adjacent grill grate pieces.

More specifically, the first and second opposing arms may be canted at an angle between 30 and 60 degrees with respect to the medial portion. The plurality of grill grate pieces may have varying longitudinal lengths. Each grill grate piece may have a V-shaped cross-sectional shape. Each grill grate piece may comprise metallic material.

Another aspect is directed to a method for making a portable grilling device. The method may include forming a plurality of grill grate pieces to be in an interlocking arrangement to define a grilling surface. Each grill grate piece may comprise first and second opposing arms, and a medial portion between the first and second opposing arms. A distal portion of the first opposing arm may define a recess, and a distal portion of the second opposing arm may comprise a tab portion extending outward therefrom. The method may include forming respective recesses configured to receive respective tab portions from adjacent grill grate pieces to define the interlocking arrangement.

### BRIEF DESCRIPTION OF THE DRAWINGS

FIG. 1 is a schematic perspective view of a portable grilling device, according to the present disclosure.

FIGS. 2A-2B are schematic perspective views of a single grill grate piece from the portable grilling device of FIG. 1.

FIG. 3 is a schematic top plan view of the plurality of grill grate pieces from the portable grilling device of FIG. 1.

FIG. 4 is a schematic side view of the plurality of grill grate pieces from the portable grilling device of FIG. 1.

FIG. 5 is a schematic side view of another embodiment of the plurality of grill grate pieces from the portable grilling device of FIG. 1.

FIG. 6 is a schematic side view of yet another embodiment of the grill grate piece from the portable grilling device of FIG. 1.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

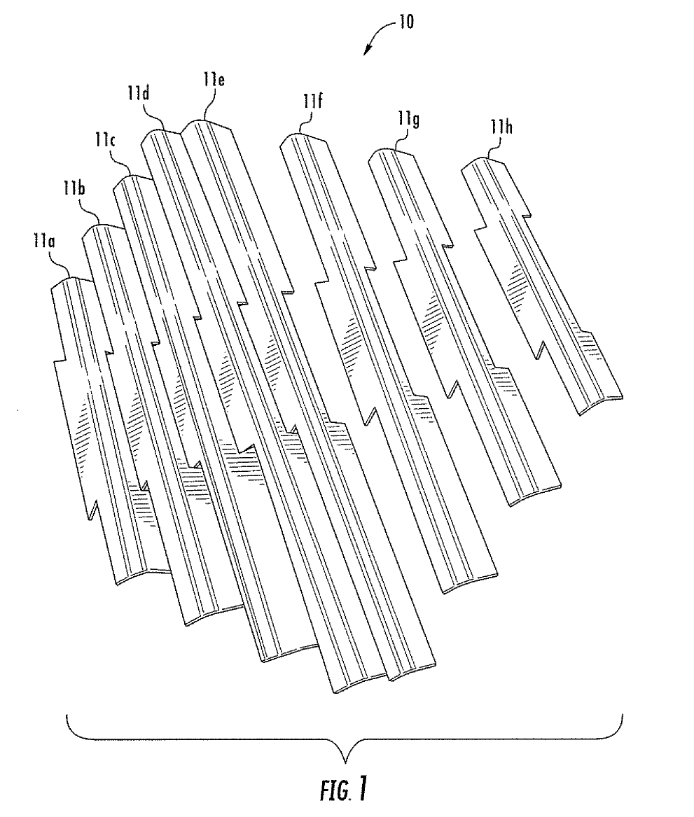

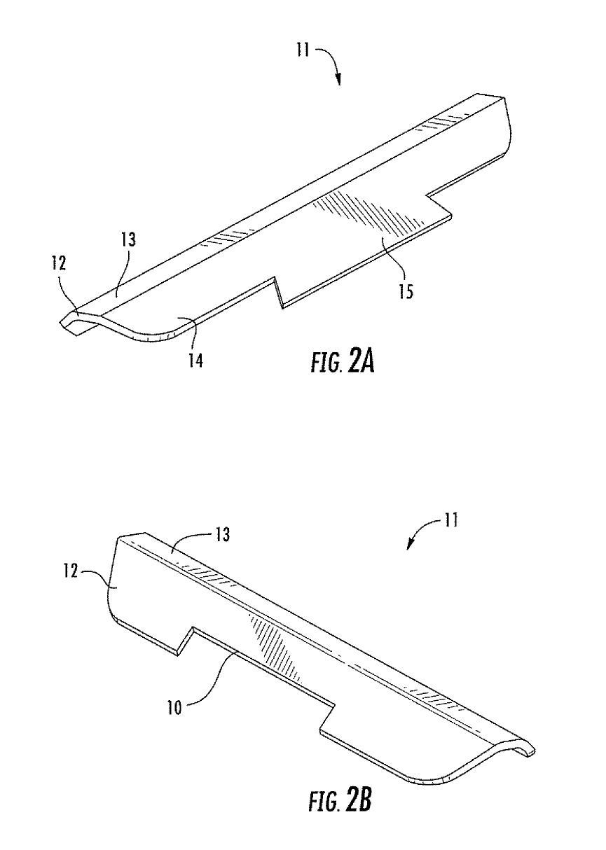

Referring initially to FIGS. 1-4, a portable grilling device 10 according to the present disclosure is now described. The portable grilling device 10 illustratively includes a plurality of grill grate pieces 11a-11h being in an interlocking arrangement to define a grilling surface. Each grill grate piece 11a-11h illustratively includes first and second opposing arms 12, 14, and a medial portion 13 between the first and second opposing arms. The medial portion 13 is substantially straight in the illustrated embodiment, i.e. adjacent segments being within ±5 degrees of parallel. In other embodiments, the medial portion 13 can be radiused or curved, or even pointed.

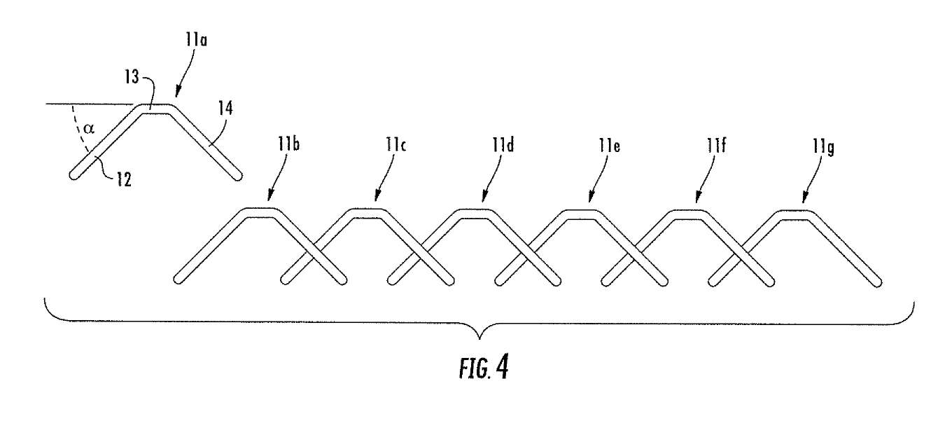

As perhaps best seen in FIG. 4, the first and second opposing arms 12, 14 are substantially straight and canted at an angle between 30 and 60 degrees with respect to the medial portion 13. With the canted first and second opposing arms 12, 14, each grill grate piece 11a-11h has a V-shaped cross-sectional (i.e. from a side view) shape.

A distal portion of the first opposing arm 12 defines a recess 16, and a distal portion of the second opposing arm 14 comprises a tab portion 15 extending outward therefrom. Respective recesses 16 are configured to receive respective tab portions 15 from adjacent grill grate pieces 11a-11h to define the interlocking arrangement. Using this feature, a user can assemble the portable grilling device 10 one grill grate piece at time.

In the illustrated embodiment, the distal portion of the first opposing arm 12 defines the recess 16 as a rectangle-shaped recess. The distal portion of the second opposing arm 14 defines the tab portion 15 comprising a trapezoid-shaped tab portion configured to be received by the rectangle-shaped recess 16 of the adjacent grill grate pieces 11a-11h. Of course, in other embodiments, the tab portion 15 and the recess 16 may have other shapes, so long as the lateral interlocking is not affected.

Positively, once interlocked, the adjacent grill grate pieces 11a-11h resist lateral detachment. Additionally, the interlocked adjacent grill grate pieces 11a-11h are configured to permit draining (e.g. draining of excess fat, sauces or oily marinades) from the grilling surface in gaps between the interlocked adjacent grill grate pieces.

It should be appreciated that the assembled grilling surface from the portable grilling device 10 is placed on top of a base grilling device, or a base generic heat source. For example, the base grilling device may include a charcoal grilling device, or a natural gas (e.g. propane) grilling device. The base generic heat source may comprise a typical stove top pan, a frying pan, a baking dish, a baking sheet, a roasting pan or an open flame. Indeed, the portable grilling device 10 is operable for any heat source to provide a grilling experience.

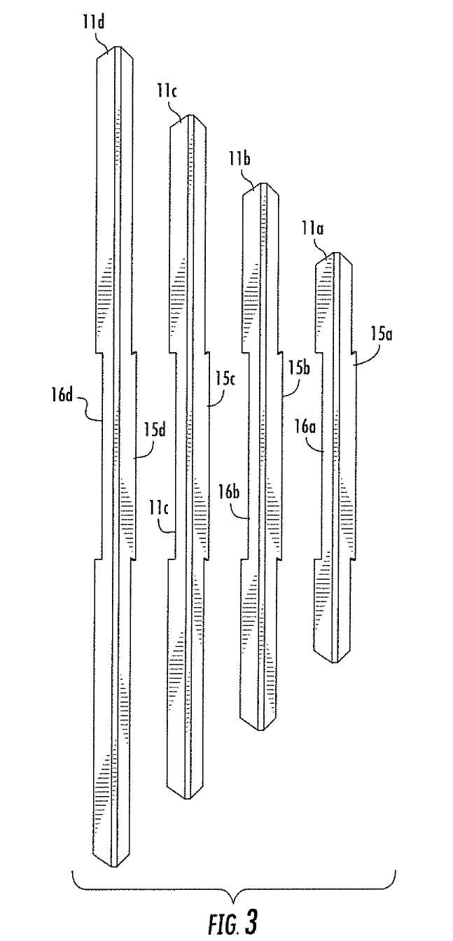

As perhaps best seen in FIG. 3, the plurality of grill grate pieces 11a-11h have varying longitudinal lengths. Advantageously, the user can assemble the portable grilling device 10 into a wide variety of shapes and configurations. For example, the portable grilling device 10 can be assembled to fit any grilling device or pan. Helpfully, this permits the user to use the portable grilling device 10 to provide a clean grilling surface in the aforementioned public grilling devices. Also, this portable grilling device 10 provides an approach to grilling activities indoors using typical pans, with safe and predictable draining of the cooking surface. In one embodiment, the portable grilling device 10 may be sold in a kit configuration, providing multiple grill grate piece sets of varying longitudinal length. This permits the user to match the portable grilling device 10 to any base grilling device.

Another advantage of the portable grilling device 10 is in the efficient draining of the grilling surface. Even while interlocked, the plurality of grill grate pieces 11a-11h permit draining from the cooking surface. Yet further, when flare-ups do occur, the portable grilling device 10 provides a protective barrier between the heat source (i.e. the fire) and food being grilled.

Each grill grate piece 11a-11h may comprise a thermally conductive material that is durable to multiple heating cycles. For example, the thermally conductive material may comprise a metallic material (steel, aluminum) or a ceramic material.

Another aspect is directed to a method for making a portable grilling device 10. The method includes forming a plurality of grill grate pieces 11a-11h to be in an interlocking arrangement to define a grilling surface. Each grill grate piece 11a-11h comprises first and second opposing arms 12, 14, and a medial portion 13 between the first and second opposing arms. A distal portion of the first opposing arm 12 defines a recess 16, and a distal portion of the second opposing arm 14 comprises a tab portion 15 extending outward therefrom. The method includes forming respective recesses 16 configured to receive respective tab portions 15 from adjacent grill grate pieces 11a-11h to define the interlocking arrangement.

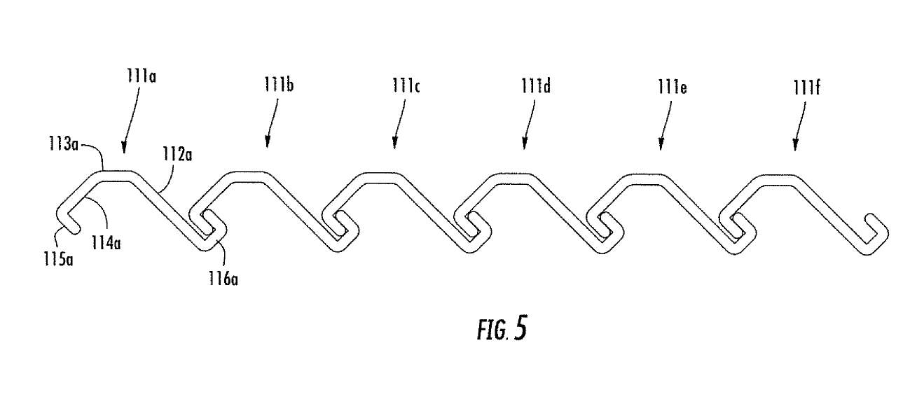

Referring now additionally to FIG. 5, another embodiment of the portable grilling device 110 is now described. In this embodiment of the portable grilling device 110, those elements already discussed above with respect to FIGS. 1-4 are incremented by 100 and most require no further discussion herein. This embodiment differs from the previous embodiment in that this portable grilling device 110 illustratively includes the distal portion of the first opposing arm 112a being C-shaped and defining the recess 116a therein. The distal portion of the second opposing arm 114a defines the tab portion 115a comprising an L-shaped tab portion configured to be received by the C-shaped distal portion of the first opposing arm 112a of the adjacent grill grate pieces 111a-111f. In some embodiments, the C-shaped first opposing arm 112a may define drain openings therein for draining the cooking surface.

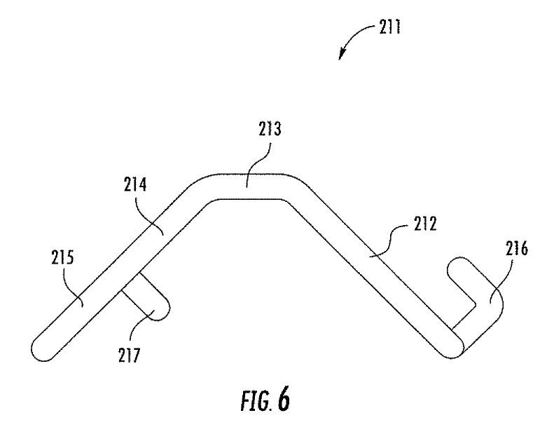

Referring now additionally to FIG. 6, another embodiment of the portable grilling device 210 is now described. In this embodiment of the portable grilling device 210, those elements already discussed above with respect to FIGS. 1-4 are incremented by 200 and most require no further discussion herein. This embodiment differs from the previous embodiment in that this portable grilling device (like the embodiment of FIG. 5) 210 illustratively includes the distal portion of the first opposing arm 212 defines the recess 216 comprising a C-shaped recess. The distal portion of the second opposing arm 214 defines the tab portion 215 comprising an L-shaped tab portion configured to be received by the C-shaped distal portion of the first opposing arm 212 of the adjacent grill grate pieces 211. The distal portion of the second opposing arm 214 illustratively includes another tab portion 217 extending transverse (or substantially perpendicular, i.e. 70-110 degrees canting) to a main portion of the second opposing arm.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A portable grilling device comprising:
a plurality of grill grate pieces being in an interlocking arrangement to define a grilling surface, each grill grate piece comprising
first and second opposing arms, and
a medial portion between said first and second opposing arms,
a distal portion of said first opposing arm defining a recess,
a distal portion of said second opposing arm comprising a tab portion extending outward therefrom;
respective recesses configured to receive respective tab portions from adjacent grill grate pieces to define the interlocking arrangement.

2. The portable grilling device of claim 1 wherein the distal portion of said first opposing arm is C-shaped and defines the recess therein.

3. The portable grilling device of claim 2 wherein the distal portion of said second opposing arm defines the tab portion comprising an L-shaped tab portion configured to be received by the C-shaped distal portion of said first opposing arm of the adjacent grill grate pieces.

4. The portable grilling device of claim 1 wherein the distal portion of said first opposing arm defines the recess as a rectangle-shaped recess.

5. The portable grilling device of claim 4 wherein the distal portion of said second opposing arm defines the tab portion comprising a trapezoid-shaped tab portion configured to be received by the rectangle-shaped recess of the adjacent grill grate pieces.

6. The portable grilling device of claim 1 wherein said first and second opposing arms are canted at an angle between 30 and 60 degrees with respect to said medial portion.

7. The portable grilling device of claim 1 wherein said plurality of grill grate pieces have varying longitudinal lengths.

8. The portable grilling device of claim 1 wherein each grill grate piece has a V-shaped cross-sectional shape.

9. The portable grilling device of claim 1 wherein each grill grate piece comprises metallic material.

10. A portable grilling device comprising:
a plurality of grill grate pieces being in an interlocking arrangement to define a grilling surface, each grill grate piece having a V-shaped cross-sectional shape and comprising
first and second opposing arms, and
a medial portion between said first and second opposing arms,
a distal portion of said first opposing arm defining a recess,
a distal portion of said second opposing arm comprising a tab portion extending outward therefrom;
respective recesses configured to receive respective tab portions from adjacent grill grate pieces to define the interlocking arrangement;
said plurality of grill grate pieces having varying longitudinal lengths.

11. The portable grilling device of claim 10 wherein the distal portion of said first opposing arm is C-shaped and defines the recess therein.

12. The portable grilling device of claim 11 wherein the distal portion of said second opposing arm defines the tab portion comprising an L-shaped tab portion configured to be received by the C-shaped distal portion of said first opposing arm of the adjacent grill grate pieces.

13. The portable grilling device of claim 10 wherein the distal portion of said first opposing arm defines the recess as a rectangle-shaped recess.

14. The portable grilling device of claim 13 wherein the distal portion of said second opposing arm defines the tab portion comprising a trapezoid-shaped tab portion configured to be received by the rectangle-shaped recess of the adjacent grill grate pieces.

15. The portable grilling device of claim 10 wherein said first and second opposing arms are canted at an angle between 30 and 60 degrees with respect to said medial portion.

16. The portable grilling device of claim 10 wherein each grill grate piece comprises metallic material.

17. A method for making a portable grilling device comprising:
forming a plurality of grill grate pieces to be in an interlocking arrangement to define a grilling surface, each grill grate piece comprising
first and second opposing arms, and
a medial portion between the first and second opposing arms,
a distal portion of the first opposing arm defining a recess,
a distal portion of the second opposing arm comprising a tab portion extending outward therefrom;
forming respective recesses configured to receive respective tab portions from adjacent grill grate pieces to define the interlocking arrangement.

18. The method of claim 17 wherein the distal portion of the first opposing arm is C-shaped and defines the recess therein; and wherein the distal portion of the second opposing arm defines the tab portion comprising an L-shaped tab portion configured to be received by the C-shaped distal portion of the first opposing arm of the adjacent grill grate pieces.

19. The method of claim 17 wherein the distal portion of the first opposing arm defines the recess as a rectangle-shaped recess; and wherein the distal portion of the second opposing arm defines the tab portion comprising a trapezoid-shaped tab portion configured to be received by the rectangle-shaped recess of the adjacent grill grate pieces.

20. The method of claim 17 wherein the first and second opposing arms are canted at an angle between 30 and 60 degrees with respect to the medial portion.
